(19) United States
(12) Patent Application Publication
(10) Pub. No.: US 2022/0046875 A1
(43) Pub. Date: Feb. 17, 2022

(54) HYDROPONIC SYSTEM WITH VERTICALLY ORIENTED PLANT BEDS

(71) Applicant: NW Farms, Inc., Auburn, WA (US)

(72) Inventors: Robert Bryce Clemmer, Auburn, WA (US); Zachary Haberlach, Auburn, WA (US)

(21) Appl. No.: 16/991,970

(22) Filed: Aug. 12, 2020

(51) Int. Cl. A01G 31/04; A01G 7/04; B25J 9/00; B25J 9/16

(52) U.S. Cl. CPC A01G 31/042; B25J 9/1679; B25J 9/0093; A01G 7/045

(57) ABSTRACT

A tower assembly for use with an overhead conveyor of a hydroponic vertical farm system. The tower assembly includes a tower frame, a face plate, and a connector. The tower frame has a top portion opposite a bottom portion. The face plate is configured to be removably attached to the tower frame. When the face plate is attached to the tower frame, the face plate is configured to support at least one plant as the at least one plant grows. The connector is attached to the top portion of the tower frame. The connector is configured to be removably attached to the overhead conveyor.

### BACKGROUND OF THE INVENTION

### Field of the Invention

The present invention is directed generally to hydroponic grow systems and more particularly to vertically oriented hydroponic systems.

### Description of the Related Art

Hydroponic systems allow food to be grown indoors within a limited amount of space. As global demand for food increases, new hydroponic systems are being developed to help satisfy that demand.

### BRIEF DESCRIPTION OF THE SEVERAL VIEWS OF THE DRAWING(S)

Various embodiments in accordance with the present disclosure will be described with reference to the following drawings.

FIG. 1 is a block diagram illustrating components of an indoor hydroponic vertical farm system.

FIG. 2 is a top perspective view of an embodiment of the indoor hydroponic vertical farm system illustrated in FIG. 1.

FIG. 3 is a top view of an overhead conveyor system of the system of FIG. 2.

FIG. 4 is a front perspective view of the system of FIG. 2.

FIG. 5 is a front perspective view of a portion of a lighting system of the system of FIG. 2.

FIG. 6 is a front perspective view of a carrier assembly carrying a plurality of vertical grow tower assemblies of the system of FIG. 2.

FIG. 7 is a front perspective view of a front face plate of one of the vertical grow tower assemblies of FIG. 6.

FIG. 8A is a back perspective view of a tower frame of one of the vertical grow tower assemblies of FIG. 6 shown with a back face plate and a hook being inserted into the tower frame.

FIG. 8B is a top perspective view of the tower frame of FIG. 8A.

FIG. 9 is a bottom perspective view of one of the vertical grow tower assemblies of FIG. 6.

FIG. 10 is a top perspective view of the vertical grow tower assembly of FIG. 9.

FIG. 11 is a back perspective view of the hook of the vertical grow tower assembly of FIG. 9.

FIG. 12 is an exploded perspective view of irrigation funnels of the vertical grow tower assembly of FIG. 9.

FIG. 13 is a top perspective view of the carrier assembly and vertical grow tower assemblies of FIG. 6 omitting the overhead conveyor system and providing a view of the vertical grow tower assemblies receiving water and nutrients from a watering system.

FIG. 14 is a front perspective view of a load bar of the carrier assembly of FIG. 6 illustrated supporting the hook of one of the vertical grow tower assemblies.

FIG. 15 is a diagram of a hardware environment and an operating environment in which one or more computer systems of the system of FIG. 1 may be implemented.

Like reference numerals have been used in the figures to identify like components.

### DETAILED DESCRIPTION OF THE INVENTION

### Overview

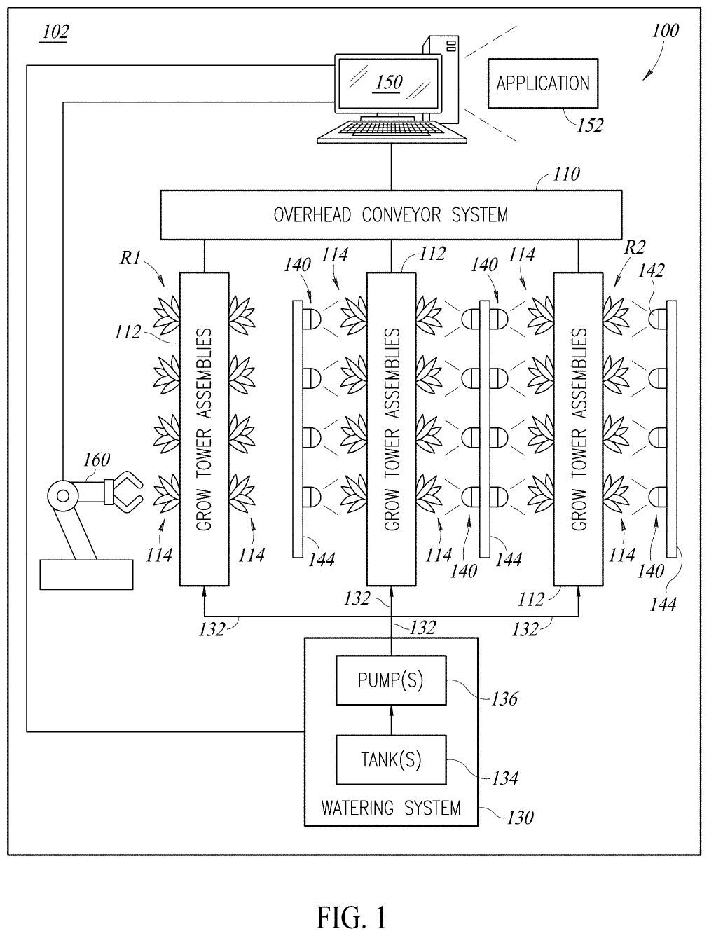

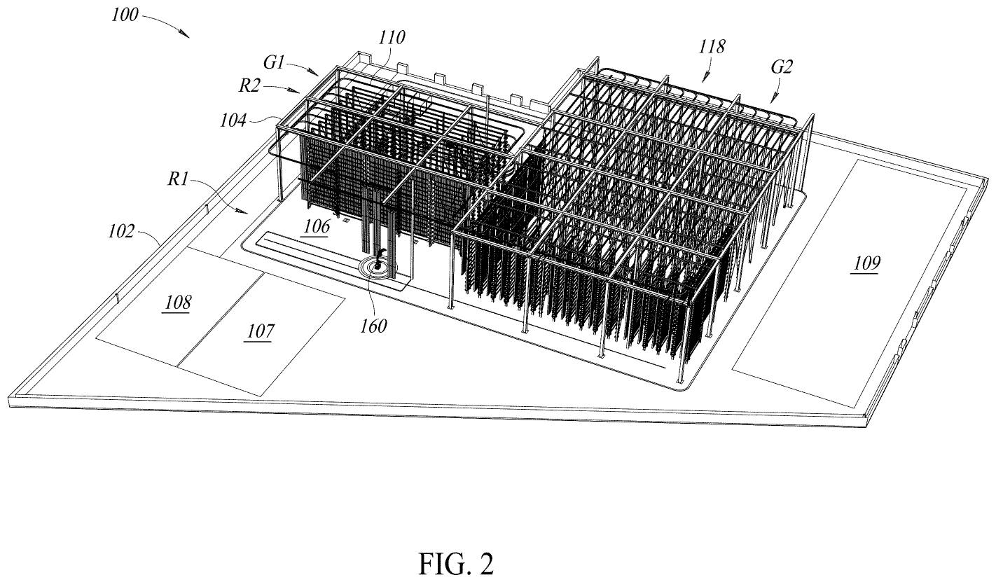

FIG. 1 is a block diagram illustrating components of a hydroponic vertical farm system 100 configured to be installed inside a building 102 and to be partially or fully automated. Referring to FIG. 2, a support structure 104 may be constructed inside the building 102 and components of the system 100 may be mounted to the support structure 104. In this manner, the system 100 may include a standard set of components that may be installed inside any building of a suitable size to accommodate the support structure 104 by simply first installing the support structure 104 inside the building 102 and then mounting the system 100 to the support structure 104.

The building 102 may be divided into regions 106-109 that may be used for specific purposes. For example, the region 106 may be occupied by the system 100, the region 107 may be dedicated to planting and/or germinating plants 114 (see FIGS. 1, 6, 9, and 13), the region 108 may be used for harvesting and/or packaging the plants 114, and the region 109 may be used for office space.

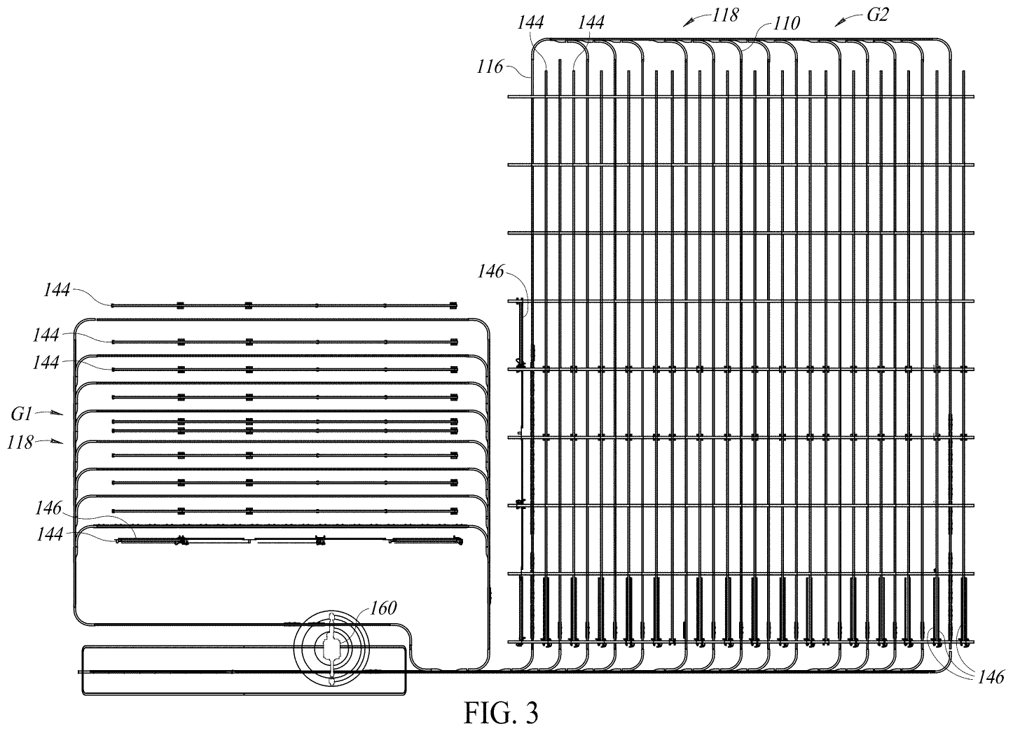

Referring to FIG. 1, the system 100 includes an overhead conveyor system 110 (e.g., built by Ultimation Industries) from which vertical grow tower assemblies 112 are hung. The overhead conveyor system 110 defines a closed loop path 116 (see FIG. 3) along which the vertical grow tower assemblies 112 travel. In the embodiment illustrated, the overhead conveyor system 110 is configured to define regions R1 and R2 within the region 106 (see FIG. 2). The region R1 is used to add newly planted ones of the vertical grow tower assemblies 112 to the overhead conveyor system 110 and to remove ones of the vertical grow tower assemblies 112 supporting fully grown plants from the overhead conveyor system 110 for harvesting. After the newly planted vertical grow tower assemblies are added to the region R1, the overhead conveyor system 110 transports the newly planted vertical grow tower assemblies to the region R2 where the plants 114 are allowed to grow. Within the region R2, the overhead conveyor system 110 may branch and define a plurality of parallel rows 118 (see FIGS. 2 and 3) along which the vertical grow tower assemblies 112 hang as the plants 114 grow. In the embodiment illustrated in FIG. 2, the overhead conveyor system 110 organizes the parallel rows 118 into two groups G1 and G2 but this is not a requirement. As shown in FIG. 3, the first group G1 may be substantially orthogonal to the second group G2. In the embodiment illustrated, the first group G1 includes eight rows and the second group G2 includes 15 rows. However, this is not a requirement.

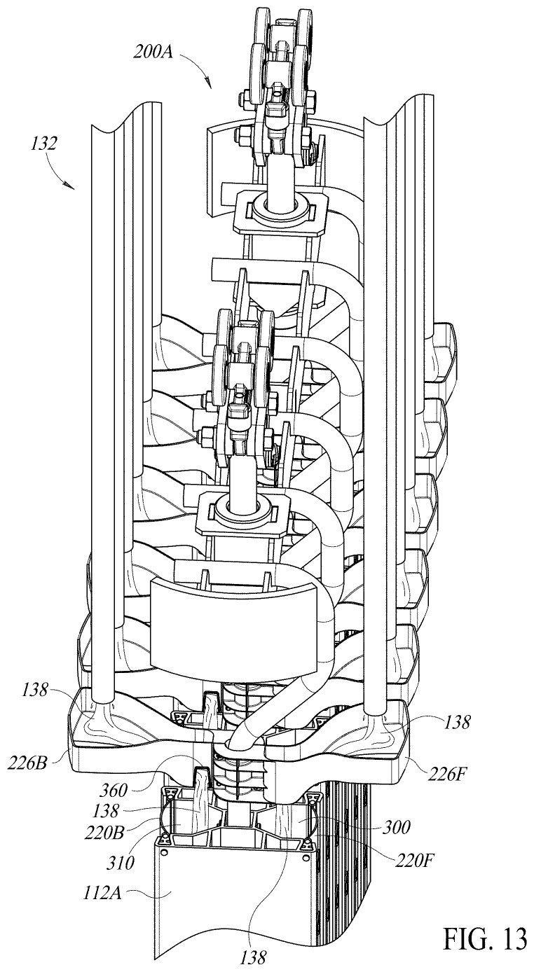

Referring to FIG. 1, the system 100 includes a watering system 130 that delivers water and nutrients 138 (see FIG. 13) to the plants 114. The watering system 130 may be implemented as a drip system that delivers water to the vertical grow tower assemblies 112 from above. The watering system 130 may include water pipes 132 (e.g., rubber water pipes or hoses) positioned on top of the overhead conveyor system 110 and configured to provide the water and nutrients 138 (see FIG. 13) directly to each of the vertical grow tower assemblies 112. The watering system 130 may include one or more tanks 134 configured to hold the water and nutrients 138 (see FIG. 13). The watering system 130 may include one or more pumps 136 configured to pump the water and nutrients 138 (see FIG. 13) from the tank(s) 134 through the water pipes 132 and to the plants 114.

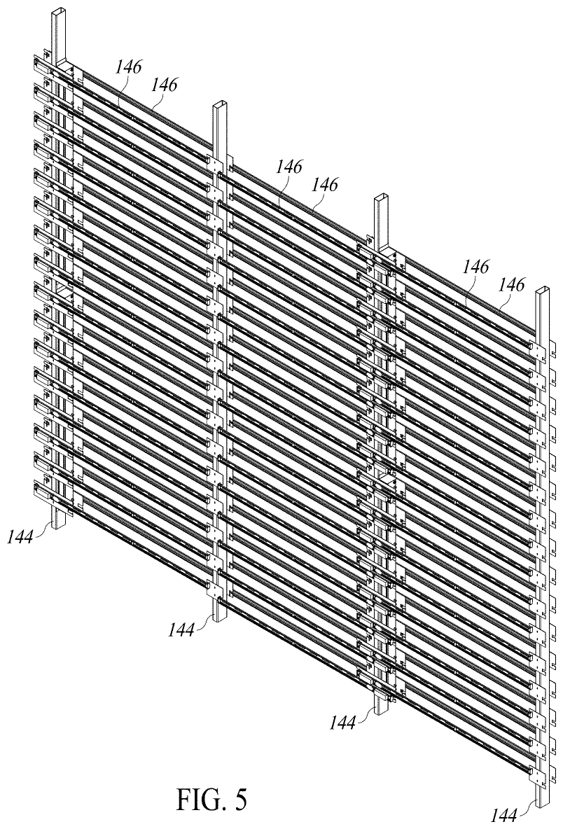

The system 100 includes a lighting system 140 that delivers artificial light to the plants 114 instead and in place of natural sunlight. The light delivered is configured to satisfy the needs of the plants 114. The lighting system 140 includes lights 142 that may be implemented as strips or strings of light emitting diodes (“LEDs”) 146 (see FIGS. 3-5). For example, referring to FIG. 3, two-sided LED lights may be strung between adjacent ones of the rows 118. In the embodiment illustrated in FIG. 1, the lights 142 are mounted on one or more racks 144 positions alongside the rows 118.

The system 100 includes at least one computer system 150 configured to execute an application 152. When executing the application 152, the computer system(s) 150 is configured to control the overhead conveyor system 110. Thus, the overhead conveyor system 110 is automated and operated by the application 152 executing on the computer system(s) 150. The application 152 is configured to instruct the overhead conveyor system 110 where to place each of the vertical grow tower assemblies 112 within the system 100. For example, the overhead conveyor system 110 may include a number of switches that determine whether the vertical grow tower assemblies 112 traveling on a segment of the overhead conveyor system 110 turn down a particular one of the rows 118 (see FIGS. 2 and 3) or continue traveling on the segment. The vertical grow tower assemblies 112 may be placed within the system 100 in accordance with a floor plan. The application 152 may also be configured to control the watering system 130 and/or the lighting system 140. In the embodiment illustrated, the application 152 is connected to the watering system 130 and determines when the plants 114 supported by each of the vertical grow tower assemblies 112 receives a portion of the water and nutrients 138 (see FIG. 13). Similarly, the application 152 may be connected to the lighting system 140 and configured to determine when the plants 114 within each of the rows 118 (see FIGS. 2 and 3) or portions of the rows 118 receive light.

The system 100 may include one or more automated robots configured to plant the plants 114 in the vertical grow tower assemblies 112, to attach the newly planted vertical grow tower assemblies 112 to the overhead conveyor system 110, to detach the vertical grow tower assemblies 112 from the overhead conveyor system 110 when the plants 114 are ready to be harvested, and to harvest the plants 114. In the embodiment illustrated, the system 100 includes a robot 160 positioned in the region R1. The robot 160 is positioned and configured to attach the vertical grow tower assemblies 112 to the overhead conveyor system 110 and to detach the vertical grow tower assemblies 112 from the overhead conveyor system 110 when the plants 114 are ready for harvesting. The robot 160 may be implemented as a robotic arm, such as a FANUC R-2000Ia/165F sold by FANUC America Corporation.

The application 152 may be configured to control the robot 160. For example, the application 152 may instruct the robot 160 to plant the plants 114 in the vertical grow tower assemblies 112. Then, the application 152 may instruct the robot 160 to attach the vertical grow tower assemblies 112 to the overhead conveyor system 110. Next, the application 152 may instruct the overhead conveyor system 110 where to place each of the vertical grow tower assemblies 112 within the system 100 to allow the plants 114 to grow. The application 152 may instruct the lighting system 140 to provide artificial light to the plants 114 as needed and the application 152 may instruct the watering system 130 to provide the water and nutrients 138 (see FIG. 13) to the plants 114 as needed. Once the plants 114 growing in a particular one of the vertical grow tower assemblies 112 are ready to be harvested, the application 152 may direct the overhead conveyor system 110 to position that particular vertical grow tower in the region R1 alongside the robot 160. Then, the application 152 may instruct the robot 160 to detach the particular vertical grow tower from the overhead conveyor system 110 so that the plants 114 may be harvested. In some embodiments, the application 152 may instruct the robot 160 to harvest the plants 114 from the particular vertical grow tower assembly. After the plants 114 have been removed from the particular vertical grow tower, the particular vertical grow tower may be replanted and hung from the overhead conveyor system 110 again. Because the system 100 is operated indoors, the plants 114 may be germinated, planted, and grown continuously year round.

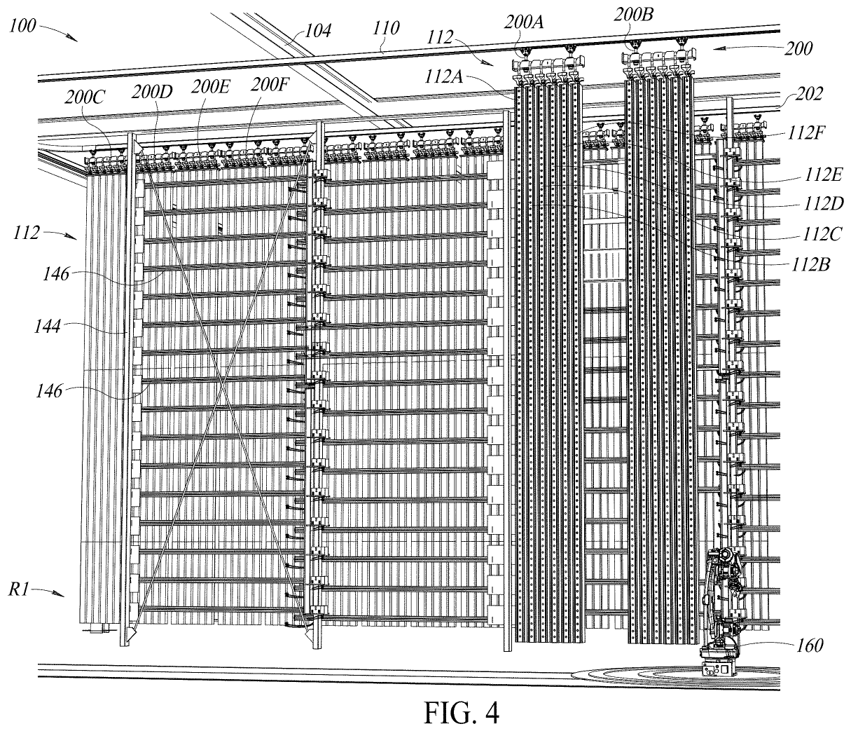

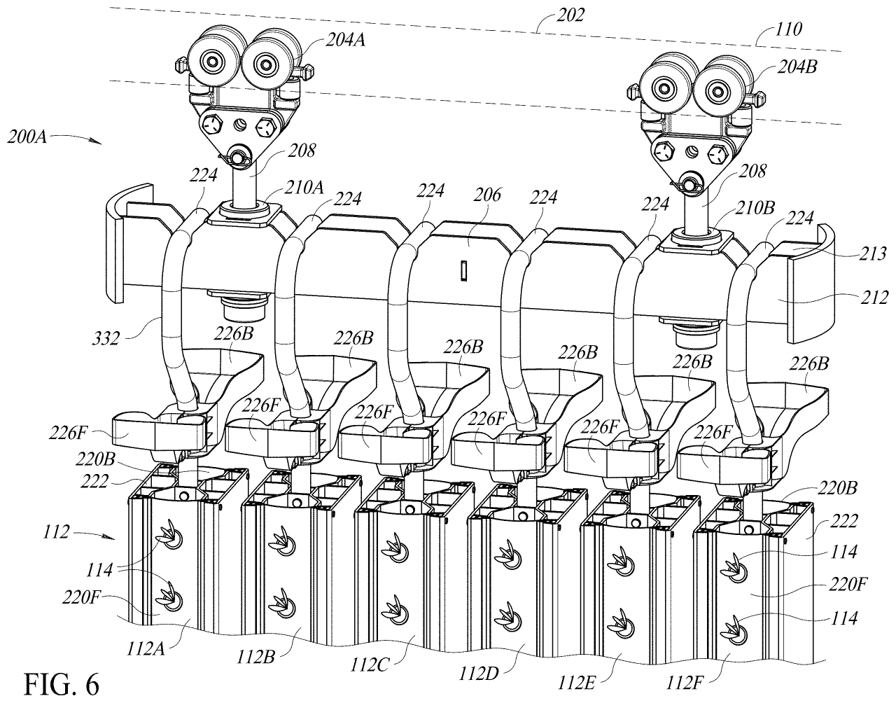

As shown in FIG. 4, the overhead conveyor system 110 may include a plurality of carrier assemblies 200 (e.g., carrier assemblies 200A-200F) configured to travel along a track 202. Referring to FIG. 6, in the embodiment illustrated, each of the carrier assemblies 200 (e.g., the carrier assembly 200A) includes one or more trolley assemblies 204A and 204B and a load bar 206. The trolley assemblies 204A and 204B are substantially identical to one another and are configured to move along the track 202. In the embodiment illustrated, the trolley assemblies 204A and 204B are spaced apart from one another and the load bar 206 extends therebetween. The trolley assemblies 204A and 204B space the load bar 206 apart vertically from the track 202. Each of the trolley assemblies 204A and 204B includes a connector portion 208.

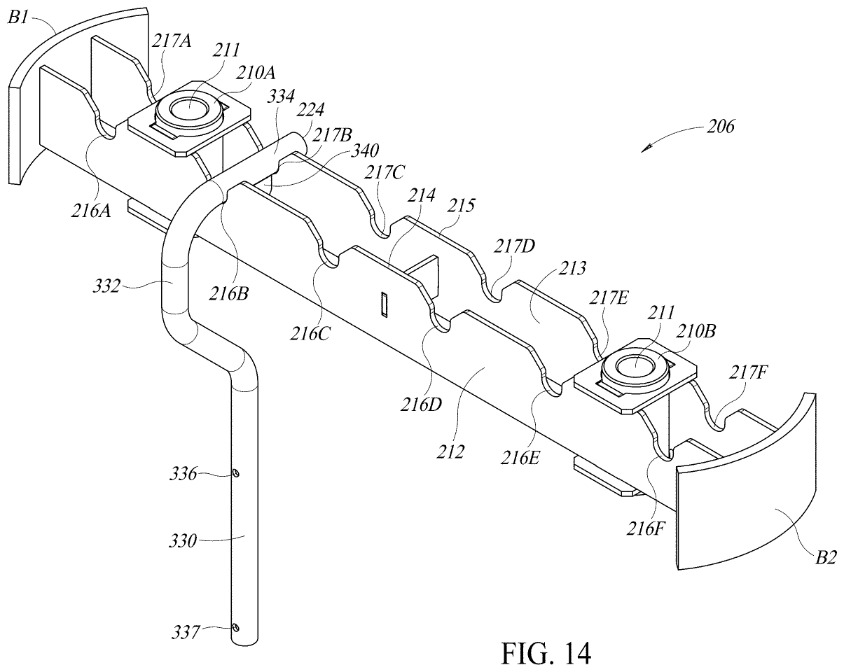

Referring to FIG. 14, the load bar 206 includes connectors 210A and 210B configured to be connected to the connector portions 208 (see FIG. 6) of the trolley assemblies 204A and 204B (see FIG. 6), respectively. Referring to FIG. 6, the connector portions 208 may be implemented as generally cylindrically shaped rods. In the embodiment illustrated in FIG. 14, the connectors 210A and 210B have each been implemented as a generally cylindrically shaped bearing housing having an open-ended vertical through-channel 211 therein. The through-channels 211 of the connectors 210A and 210B are configured to receive the connector portions 208 (see FIG. 6) of the trolley assemblies 204A and 204B (see FIG. 6), respectively. Referring to FIG. 6, the vertical through-channel 211 (see FIG. 14) of the connector 210A is configured to allow the trolley assembly 204A to rotate therein as the carrier assembly 200A travels around curved portions of the track 202. Similarly, the vertical through-channel 211 (see FIG. 14) of the connector 210B is configured to allow the trolley assembly 204B to rotate therein as the carrier assembly 200A travels around curved portions of the track 202. Bearings may be positioned inside the through-channels 211 (see FIG. 14) between the connectors 210A and 210B and the connector portions 208 of the trolley assemblies 204A and 204B, respectively.

Referring to FIG. 14, the connectors 210A and 210B are mounted between parallel first and second rails 212 and 213. The first and second rails 212 and 213 are substantially identical to one another. The first rail 212 includes an upper edge 214 with seats 216A-216F formed therein, and the second rail 213 includes an upper edge 215 with seats 217A-217F formed therein. In the embodiment illustrated, the seats 216A-216F have been implemented as cutouts formed in the upper edge 214 and the seats 217A-217F have been implemented as cutouts formed in the upper edge 215. The seats 216A-216F are aligned with the seats 217A-217F, respectively.

The load bar 206 includes first and second bumpers B1 and B2. The first and second rails 212 and 213 each extend from the first bumper B1 to the second bumper B2. The first and second bumpers B1 and B2 may be curved and are configured to protect the first and second rails 212 and 213 from collisions with other ones of the carrier assemblies 200 (see FIG. 4).

As shown in FIG. 6, a predetermined number (e.g., six) of the vertical grow tower assemblies 112 (e.g., vertical grow tower assemblies 112A-112F) may be hung together side-by-side on the load bar 206. For example, the carrier assembly 200A is configured to carry the vertical grow tower assemblies 112A-112F along the track 202 as a unit. The vertical grow tower assemblies 112A-112F are mounted in the seats 216A-216F (see FIG. 14), respectively, of the first rail 212 and the seats 217A-217F (see FIG. 14), respectively, of the second rail 213.

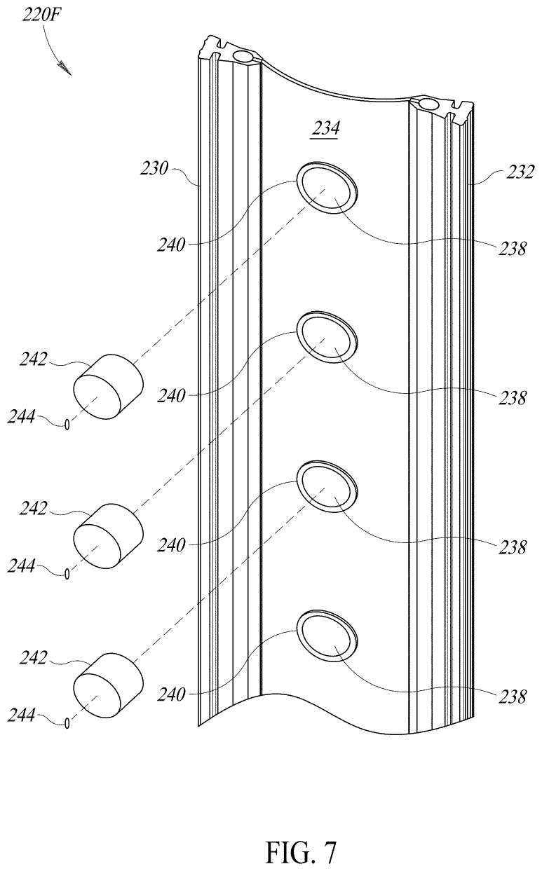

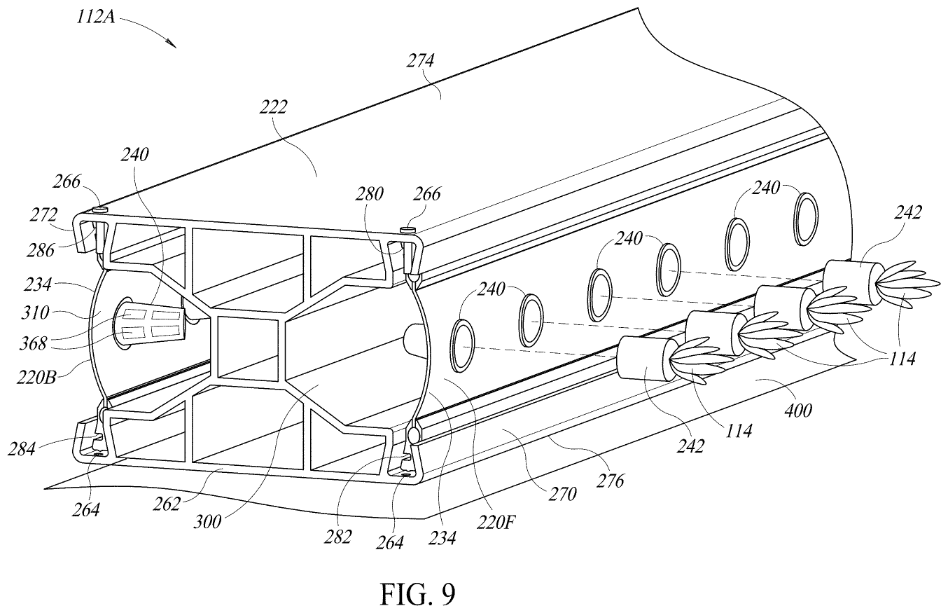

Each of the vertical grow tower assemblies 112 includes a front face plate 220F, a back face plate 220B, a tower frame 222, a hook 224, a front irrigation funnel 226F, and a back irrigation funnel 226B. The front and back face plates 220F and 220B are substantially identical to one another and configured to be slid into and out of the tower frame 222. Referring to FIG. 7, the front and back face plates 220F and 220B (see FIGS. 6, 9, and 13) each have a first edge portion 230 opposite a second edge portion 232 and a central portion 234 that extends from the first edge portion 230 to the second edge portion 232. In the embodiment illustrated in FIG. 9, the central portion 234 curves outwardly away from the tower frame 222. In other words, the central portion 234 may be generally convex with respect to the tower frame 222. The first and second edge portions 230 and 232 (see FIG. 7) are configured to be slid into the tower frame 222 and to anchor the front and back face plates 220F and 220B to the tower frame 222. Referring to FIG. 7, in the embodiment illustrated, the first and second edge portions 230 and 232 taper outwardly away from the central portion 234. Thus, the first and second edge portions 230 and 232 may have a generally triangular cross-sectional shape that is thinnest along the central portion 234 and thicker further away from the central portion 234.

In the embodiment illustrated in FIG. 7, the front and back face plates 220F and 220B (see FIGS. 6, 9, and 13) each include a plurality of cups or baskets 240. The baskets 240 may be arranged in a linear pattern that extends along each of the front and back face plates 220F and 220B (see FIGS. 6, 9, and 13). Each of the baskets 240 has an opening 238 configured to receive growth media 242 in which at least one seed 244 has been or will be planted. The seeds 244 may subsequently be allowed to germinate in the baskets 240. For example, the seeds 244 may be planted in the growth media 242 in the baskets 240 of the front face plate 220F and allowed to germinate in the baskets 240 before the front face plate 220F is slid into the tower frame 222. Alternatively, the seeds 244 may be planted in the growth media 242 and allowed to germinate. Then, the growth media 242 may be relocated to the baskets 240 of the front face plate 220F shortly before the front face plate 220F is slid into the tower frame 222. The same planting procedure performed with respect to the front face plate 220F may be performed with respect to the back face plate 220B (see FIGS. 6, 8A, 9, and 13). Additionally, the same harvesting procedure may be performed with respect to the front and back face plates 220F and 220B.

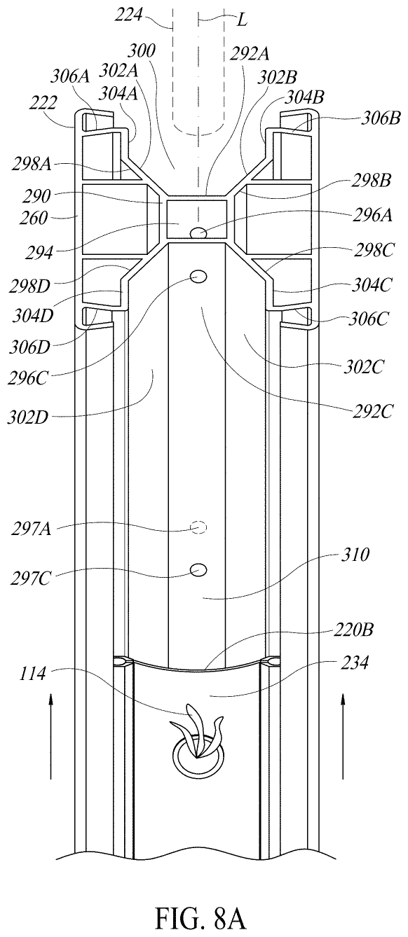

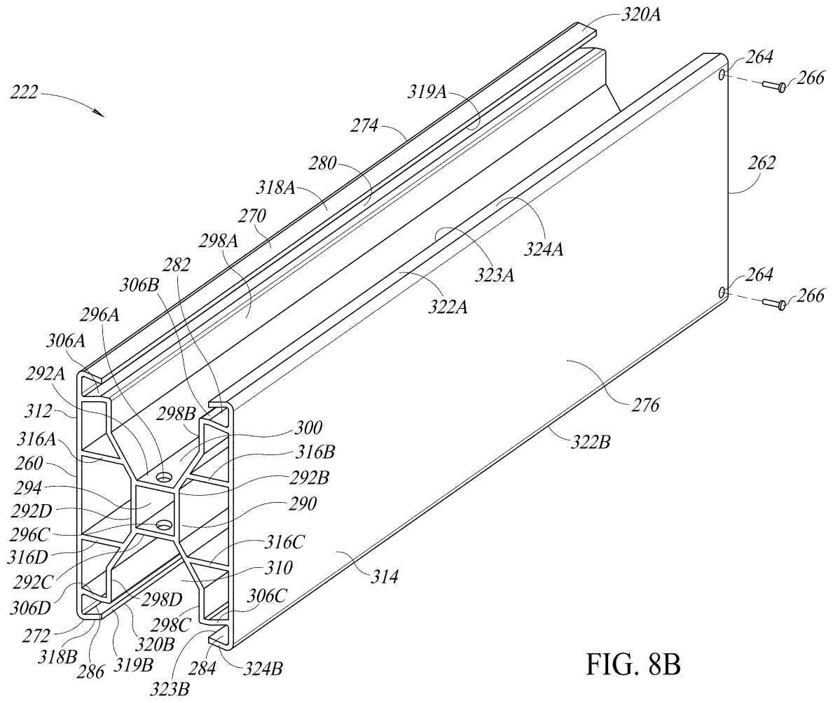

Referring to FIG. 8A, the tower frame 222 extends along a longitudinal axis “L” that is oriented vertically when the tower frame 222 is suspended from the overhead conveyor system 110 (see FIGS. 1-4 and 6). The tower frame 222 may have a height ranging from about 20 feet to about 30 feet. For example, the tower frame 222 may be 20 feet tall. Referring to FIG. 8B, the tower frame 222 has a top portion 260 opposite a bottom portion 262. The bottom portion 262 has through-holes 264 formed therein configured to receive pins 266. In the embodiment illustrated, the tower frame 222 has a front facing side 270 opposite a back facing side 272 and a first side portion 274 opposite a second side portion 276. The front and back facing sides 270 and 272 are mirror images of one another and the first and second side portions 274 and 276 are mirror images of one another.

At the front facing side 270, the tower frame 222 has a longitudinally extending first channel or groove 280 positioned on the first side portion 274 and a longitudinally extending second channel or groove 282 positioned on the second side portion 276. The first and second grooves 280 and 282 are juxtaposed laterally from one another and configured to receive the first and second edge portions 230 and 232 (see FIG. 7), respectively, of the front face plate 220F (see FIGS. 6, 7, 9, and 13). Referring to FIG. 9, the front face plate 220F is configured to slide within the first and second grooves 280 and 282 longitudinally. As shown in FIG. 9, the grooves 280 and 282 may each have generally triangular cross-sectional shapes that helps maintain the first and second edge portions 230 and 232 (see FIG. 7), respectively, of the front face plate 220F therein.

Referring to FIG. 8B, at the back facing side 272, the tower frame 222 has a longitudinally extending third channel or groove 284 positioned on the second side portion 276 and a longitudinally extending fourth channel or groove 286 positioned on the first side portion 274. The third and fourth grooves 284 and 286 are juxtaposed laterally from one another and configured to receive the first and second edge portions 230 and 232 (see FIG. 7), respectively, of the back face plate 220B (see FIGS. 6, 8A, 9, and 13). As shown in FIG. 9, the grooves 284 and 286 may each have generally triangular cross-sectional shapes that helps maintain the first and second edge portions 230 and 232 (see FIG. 7), respectively, of the back face plate 220B therein.

The through-holes 264 (see FIG. 8B) formed in the bottom portion 262 are in communication with the first and third grooves 280 and 286 and/or the second and fourth grooves 282 and 284. In other words, referring to FIG. 8B, one of the through-holes 264 is positioned to be in communication with the groove 280 or the groove 282 and a different one of the through-holes 264 is positioned to be in communication with the groove 284 or the groove 286. Thus, the pins 266 block at least one of the first and second grooves 280 and 282 and at least one of the third and fourth grooves 284 and 286. Referring to FIG. 9, the pins 266 are configured to be inserted into the through-holes 264 (see FIG. 8B) to prevent the front and back face plates 220F and 220B from sliding downwardly and at least partially exiting the tower frame 222 through the bottom portion 262 when the tower frame 222 is in a vertical orientation. The pins 266 may be inserted into the through-holes 264 (see FIG. 8B) in communication with the second and fourth grooves 282 and 284 when the tower frame 222 is positioned on the first side portion 274. Similarly, as shown in FIG. 9, the pins 266 may be inserted into the through-holes 264 (see FIG. 8B) in communication with the first and third grooves 280 and 286 when the tower frame 222 is positioned on the second side portion 276.

Referring to FIG. 8B, the tower frame 222 has a longitudinally extending central portion 290. In the embodiment illustrated, the central portion 290 has a generally square cross-sectional shape. The central portion 290 includes longitudinally extending sidewalls 292A-292D that define a longitudinally extending open-ended central through-channel 294. The sidewalls 292A and 292C are opposite one another and the sidewalls 292B and 292D are opposite one another. Referring to FIG. 8A, the sidewall 292A has through-holes 296A and 297A formed therein and the sidewall 292C has through-holes 296C and 297C formed therein. The through-holes 296A and 296C are aligned with one another across the central through-channel 294 and the through-holes 296A and 296C are aligned with one another across the central through-channel 294.

In the embodiment illustrated in FIG. 8B, a sidewall 298A extends outwardly from an intersection of the sidewalls 292A and 292D and a sidewall 298B extends outwardly from an intersection of the sidewalls 292A and 292B. A longitudinally extending open-ended front through-channel 300 is defined between the sidewalls 292A, 298A, and 298B. In the embodiment illustrated in FIG. 8A, the sidewall 298A has an angled proximal portion 302A, an intermediate portion 304A, and a distal portion 306A. Similarly, the sidewall 298B has an angled proximal portion 302B, an intermediate portion 304B, and a distal portion 306B. The angled proximal portions 302A and 302B are each attached to the central portion 290 and widen the front through-channel 300. The intermediate portions 304A and 304B are substantially parallel with one another. The distal portions 306A and 306B are bent outwardly away from the front through-channel 300 in opposite directions.

Referring to FIG. 8B, a sidewall 298C extends outwardly from an intersection of the sidewalls 292B and 292C. Similarly, a sidewall 298D extends outwardly from an intersection of the sidewalls 292C and 292D. A longitudinally extending open-ended back through-channel 310 is defined between the sidewalls 292C, 298C, and 298D. In the embodiment illustrated in FIG. 8A, the sidewall 298C has an angled proximal portion 302C, an intermediate portion 304C, and a distal portion 306C. Similarly, the sidewall 298D has an angled proximal portion 302D, an intermediate portion 304D, and a distal portion 306D. The angled proximal portions 302C and 302D are each attached to the central portion 290 and widen the back through-channel 310. The intermediate portions 304C and 304D are substantially parallel with one another. The distal portions 306C and 306D are bent outwardly away from the front through-channel 300 in opposite directions. In the embodiment illustrated, the distal portions 306A and 306D bend toward one another and the distal portions 306B and 306C bend toward one another.

Referring to FIG. 8B, a first plate or member 312 is attached to free ends of the distal portions 306A and 306D and a second plate or member 314 is attached to free ends of the distal portions 306B and 306C. Supports 316A and 316D may extend between the first member 312 and the sidewalls 298A and 298D, respectively. Similarly, supports 316B and 316C may extend between the second member 314 and the sidewalls 298B and 298C, respectively.

A first distal portion 318A of the first member 312 extends outwardly beyond the distal portion 306A and a second distal portion 318B of the first member 312 extends outwardly beyond the distal portion 306D. The first distal portion 318A may be bent inwardly near its first edge 319A to define a first flange 320A that extends toward the front through-channel 300. The first groove 280 is defined between the first flange 320A and the distal portion 306A. The second distal portion 318B may be bent inwardly near its second edge 319B to define a second flange 320B that extends toward the back through-channel 310. The fourth groove 286 is defined between the second flange 320B and the distal portion 306D.

A first distal portion 322A of the second member 314 extends outwardly beyond the distal portion 306B and a second distal portion 322B of the second member 314 extends outwardly beyond the distal portion 306C. The first distal portion 322A may be bent inwardly near its first edge 323A to define a first flange 324A that extends toward the front through-channel 300. The second groove 282 is defined between the first flange 324A and the distal portion 306B. The second distal portion 322B may be bent inwardly near its second edge 323B to define a second flange 324B that extends toward the back through-channel 310. The third groove 284 is defined between the second flange 324B and the distal portion 306C.

Referring to FIG. 9, the front and back through-channels 300 and 310 are positioned behind the front and back face plates 220F and 220B, respectively. As mentioned above, the central portions 234 of the front and back face plates 220F and 220B curve outwardly and help enlarge the cross-sectional area of the front and back through-channels 300 and 310, respectively.

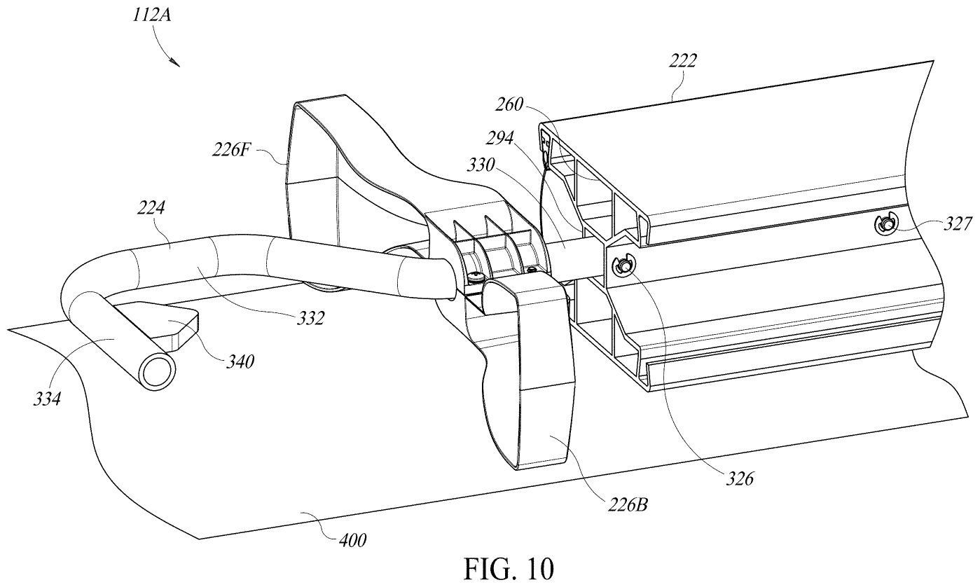

Referring to FIG. 10, the hook 224 may be attached to the tower frame 222 of the vertical grow tower assembly 112A. In the embodiment illustrated, the hook 224 is configured to be received inside the central through-channel 294 and held in place by pins 326 and 327. The pin 326 is inserted laterally through the through-holes 296A and 296C (see FIGS. 8A and 8B) of the tower frame 222 and the pin 327 is inserted laterally through the through-holes 297A and 297C (see FIG. 8A) of the tower frame 222 when the hook 224 is positioned inside the central through-channel 294 of the tower frame 222.

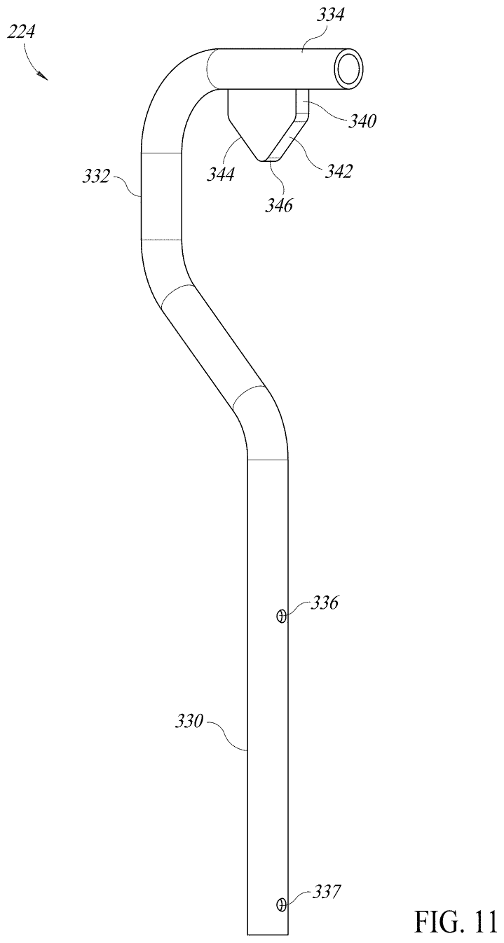

Referring to FIG. 11, the hook 224 may be constructed from a section of hollow tubing or pipe. The hook 224 includes a substantially linear lower portion 330, a curved intermediate portion 332, and a substantially linear upper portion 334. The lower and upper portions 330 and 334 may be substantially orthogonal with respect to one another. The lower portion 330 includes spaced apart through-holes 336 and 337 configured to receive the pins 326 and 327 (see FIG. 10), respectively. Thus, the through-hole 336 is positioned to be aligned with the through-holes 296A and 296C (see FIGS. 8A and 8B), and the through-hole 337 is positioned to be aligned with the through-holes 297A and 297C (see FIG. 8A). The lower portion 330 is configured to be aligned with the longitudinal axis “L” (see FIG. 8A) and inserted into the central through-channel 294. As shown in FIG. 6, the curved intermediate portion 332 is configured to curve partway around the load bar 206 to position the upper portion 334 (see FIGS. 10 and 11) above the load bar 206 when, as shown in FIG. 10, the lower portion 330 is received inside the central through-channel 294. The upper portion 334 has a downwardly extending anchor projection 340. In the embodiment illustrated, the anchor projection 340 is generally planar and has a pentagonal outer shape. Referring to FIG. 11, the anchor projection 340 has angled edges 432 and 434 that intersect and terminate at a point 346 that is centered at and aligned with the lower portion 330.

Referring to FIG. 6, the hook 224 of each of the vertical grow tower assemblies 112A-112F is configured to be hung from the first and second rails 212 and 213 of the load bar 206. As mentioned above, the seats 216A-216F (see FIG. 14) are aligned with the seats 217A-217F (see FIG. 14), respectively, to receive the hooks 224 of the vertical grow tower assemblies 112A-112F, respectively. In other words, the aligned seats 216A and 217A are configured to receive the hook 224 of the vertical grow tower assembly 112A, the aligned seats 216B and 217B are configured to receive the hook 224 of the vertical grow tower assembly 112B, the aligned seats 216C and 217C are configured to receive the hook 224 of the vertical grow tower assembly 112C, the aligned seats 216D and 217D are configured to receive the hook 224 of the vertical grow tower assembly 112D, the aligned seats 216E and 217E are configured to receive the hook 224 of the vertical grow tower assembly 112E, and the aligned seats 216F and 217F are configured to receive the hook 224 of the vertical grow tower assembly 112F. When the hooks 224 are so received, the anchor projection 340 (see FIGS. 11 and 14) of each of the hooks 224 of the vertical grow tower assemblies 112A-112F are positioned between the first and second rails 212 and 213.

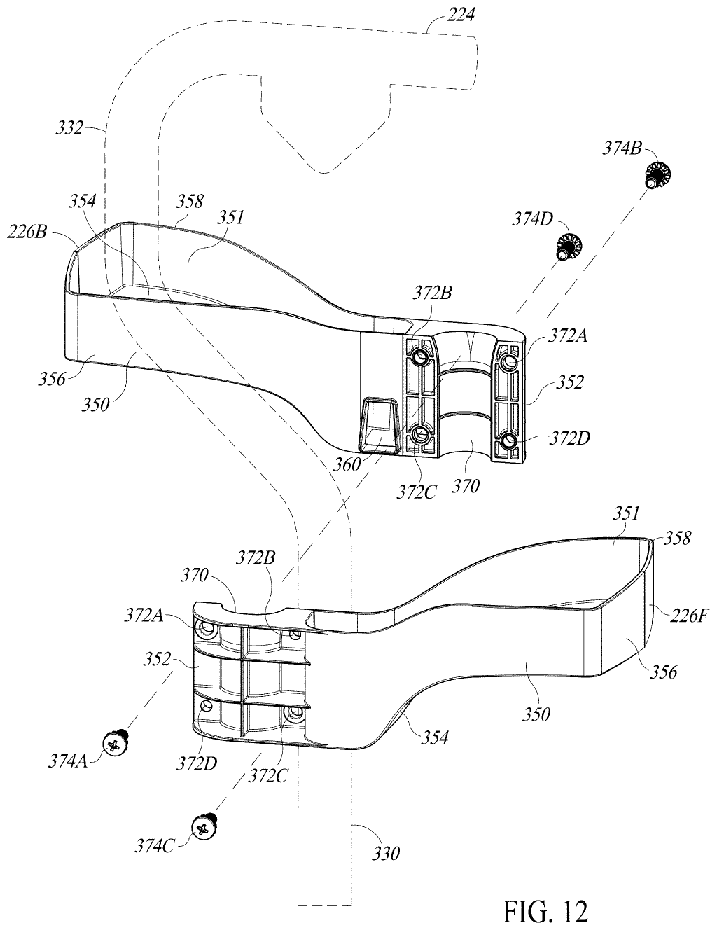

As mentioned above, referring to FIG. 6, the front and back irrigation funnels 226F and 226B are substantially identical to one another. Referring to FIG. 12, each of the front and back irrigation funnels 226F and 226B includes a water collection portion 350 attached to a connector portion 352. The water collection portion 350 may be generally cup or funnel shaped and defines a hollow interior 351 that opens upwardly. Optionally, the hollow interior 351 may be filled with a porous material (e.g., foam) that allows the water and nutrients 138 (see FIG. 13) to flow therethrough. In the embodiment illustrated, the water collection portion 350 includes a floor or base 354 surround by a sidewall 356 that together define the hollow interior 351. The sidewall 356 extends upwardly from the base 354 and has an upper free edge 358 defining an opening into the hollow interior 351. An opening 360 into the hollow interior 351 is formed in the sidewall 356. However, in alternate embodiments, the opening 360 may be formed in the base 354. In other words, at least one opening may be formed in the sidewall 356 and/or the base 354. The opening 360 may be formed near the base 354 and the connector portion 352. Any water and nutrients received inside the hollow interior 351 through the opening defined by the upper free edge 358 may exit the hollow interior 351 through the opening 360. The base 354 may be curved or tapered to help the water and nutrients 138 (see FIG. 13) flow toward the opening 360.

Referring to FIG. 13, the opening 360 of the front irrigation funnel 226F is positioned such that the water and nutrients 138 exiting the opening 360 of the front irrigation funnel 226F flow downwardly through the front through-channel 300 of the vertical grow tower assembly 112A. The baskets 240 (see FIGS. 7 and 9) of the front face plate 220F extend into the front through-channel 300 and receive at least a portion of the water and nutrients 138 flowing through the front through-channel 300. Thus, the front through-channel 300 provides a first pathway for the water and nutrients 138 to reach the roots of the plants 114 supported by the front face plate 220F. Similarly, the opening 360 of the back irrigation funnel 226B is positioned such that the water and nutrients 138 exiting the opening 360 of the back irrigation funnel 226B flow downwardly through the back through-channel 310 of the vertical grow tower assembly 112A. The baskets 240 (see FIGS. 7 and 9) of the back face plate 220B extend into the back through-channel 310 and receive at least a portion of the water and nutrients 138 flowing through the back through-channel 310. Thus, the back through-channel 310 provides a second pathway for the water and nutrients 138 to reach the roots of the plants 114 supported by the back face plate 220B. The water and nutrients 138 travel through the baskets 240 (see FIGS. 7 and 9), which each include one or more openings 368 (see FIG. 9) for the water and nutrients 138 to travel through or are otherwise permeable to the water and nutrients 138, so that the water and nutrients 138 reach the roots of the plants 114 supported by the front and back face plates 220F and 220B.

Referring to FIG. 12, the connector portion 352 includes a vertically oriented open-ended channel 370 configured to engage the lower portion 330 below the curved intermediate portion 332 of the hook 224. The connector portion 352 includes through-holes 372A-372D configured to receive fasteners 374A-374D. The connector portion 352 of the front irrigation funnel 226F is configured to be positioned on an opposite side of the lower portion 330 of the hook 224 from the connector portion 352 of the back irrigation funnel 226B with the open-ended channels 370 of the front and back irrigation funnels 226F and 226B engaging the lower portion 330 of the hook 224. When the front and back irrigation funnels 226F and 226B are in this orientation, the through-hole 372A of front irrigation funnel 226F is aligned with the through-hole 372B of the back irrigation funnel 226B and the fastener 374A may inserted into the through-hole 372A of the front irrigation funnel 226F and the through-hole 372B of the back irrigation funnel 226B. Similarly, the through-hole 372B of the front irrigation funnel 226F is aligned with the through-hole 372A of the back irrigation funnel 226B and the fastener 374B may inserted into the through-hole 372B of the front irrigation funnel 226F and the through-hole 372A of the back irrigation funnel 226B. At the same time, the through-hole 372C of the front irrigation funnel 226F is aligned with the through-hole 372D of the back irrigation funnel 226B and the fastener 374C may inserted into the through-hole 372C of the front irrigation funnel 226F and the through-hole 372D of the back irrigation funnel 226B. Further, the through-hole 372D of the front irrigation funnel 226F is aligned with the through-hole 372C of the back irrigation funnel 226B and the fastener 374D may inserted into the through-hole 372D of the front irrigation funnel 226F and the through-hole 372C of the back irrigation funnel 226B. Thus, the fasteners 374A-374D may be used to clamp the front and back irrigation funnels 226F and 226B to the lower portion 330 of the hook 224. The front and back irrigation funnels 226F and 226B may be clamped to the lower portion 330 of the hook 224 at a position above the top portion 260 of the tower frame 222. In other words, the front and back irrigation funnels 226F and 226B may be spaced apart vertically from the tower frame 222 and the track 202 (see FIGS. 4 and 6).

By way of a non-limiting example, the system 100 may be operated as follows. Referring to FIG. 7, the seeds 244 are allowed to germinate in the growth media 242 to create the plants 114 (see FIGS. 1, 6, 9, and 13), which at this stage may be characterized as being seedlings. By way of a non-limiting example, this may occur in the region 107 (see FIG. 2). Then, referring to FIG. 9, the tower frame 222 may be placed on its first side portion 274 or its second side portion 276 on a conveyor belt 400. The front and back face plates 220F and 220B are slid into place. The pins 266 may be inserted into the through-holes 264 positioned near the bottom portion 262 of the tower frame 222 before, during, or after the front and back face plates 220F and 220B are slid into place. The pins 266 help maintain the front and back face plates 220F and 220B in place in the tower frame 222.

As mentioned above, the seeds 244 (see FIG. 7) may germinate inside the baskets 240 of the front and back face plates 220F and 220B. Alternatively, the seeds 244 may germinate in the growth media 242 before the growth media 242 is placed inside the baskets 240. In such embodiments, human workers and/or one or more automated planting robots (e.g., the robot 160 illustrated in FIGS. 1-4) may place the growth media 242 (with the germinated plants 114 therein) in the baskets 240 of the front and back face plates 220F and 220B. This may be done before or after the front and back face plates 220F and 220B are slid into place in the tower frame 222.

Referring to FIG. 10, if the hook 224 is disconnected from the tower frame 222, the hook 224 may be inserted into the central through-channel 294 and attached to the top portion 260 of the tower frame 222. The front and back irrigation funnels 226F and 226B may already be attached to the hook 224 or may be attached at this point. Then, referring to FIG. 6, the robot 160 (see FIGS. 1-4) may lift the vertical grow tower assembly 112A and attach the hook 224 to the load bar 206. This process may be repeated for each of the vertical grow tower assemblies 112B-112F. Then, the carrier assembly 200A may be moved along the overhead conveyor system 110 to another location in the region R2 (see FIGS. 1 and 2) whereat the front and back irrigation funnels 226F and 226B are positioned to receive the water and nutrients 138 (see FIG. 13) from the water pipes 132 (see FIGS. 1 and 13) of the watering system 130 (see FIG. 1) and the plants 114 are allowed to grow.

When it is time to harvest the plants 114, the carrier assembly 200A may be moved along the overhead conveyor system 110 to the region R1 (see FIGS. 1, 2, and 4) whereat the robot 160 (see FIGS. 1-4) detaches the hook 224 from the load bar 206 and may lower the vertical grow tower assembly 112A to a harvesting conveyor belt (like the conveyor belt 400 illustrated in FIG. 9). This process may be repeated for each of the vertical grow tower assemblies 112B-112F. Human workers and/or one or more automated harvesting robots (e.g., the robot 160) may remove the plants 114 from the vertical grow tower assemblies 112A-112F. By way of a non-limiting example, this may occur in the region 108 (see FIG. 2). The human workers and/or the automated harvesting robot(s) remove the pins 266 from the through-holes 264 and slide the front and back face plates 220F and 220B free of the tower frame 222. At this point, the front and back face plates 220F and 220B and the tower frame 222 may be cleaned in accordance with applicable food safety laws and regulations. If required, the hook 224 and the front and back irrigation funnels 226F and 226B may also be cleaned. While the front and back face plates 220F and 220B and the tower frame 222 are being cleaned, different ones of the vertical grow tower assemblies 112 that include newly germinated plants may be hung from the load bar 206. In this manner, the system 100 (see FIG. 1) may be continuously growing the plants 114.

Referring to FIG. 9, in the food industry, food safety is paramount. As a result, all materials that touch the plants 114 must be cleaned regularly. Cleaning each of the vertical grow tower assemblies 112 (see FIG. 1) is cumbersome and time consuming. Because the front and back face plates 220F and 220B are configured to be removable from the tower frame 222, the front and back face plates 220F and 220B may be cleaned separately.

The front face plate 220F is configured to slide into and out of the first and second grooves 280 and 282 and the back face plate 220B is configured to slide into and out of the third and fourth grooves 284 and 286 to increase the efficiency at which the plants 114 may be planted and harvested. Thus, instead of harvesting single plants one at a time from the vertical grow tower assembly 112A, a machine (e.g., the robot 160 illustrated in FIGS. 1-4) may be configured to slide the front face plate 220F and the back face plate 220B into and out of the tower frame 222. Referring to FIG. 1, using the robot 160 in this manner decreases an amount of time during which the vertical grow tower assemblies 112 are removed from the overhead conveyor system 110 and, consequently, are not growing the plants 114. Thus, by decreasing the amount of time required to harvest the plants 114, an amount of time during which the vertical grow tower assemblies 112 are growing the plants 114 may be increased, which will increase the yield of the system 100.

### Computing Device

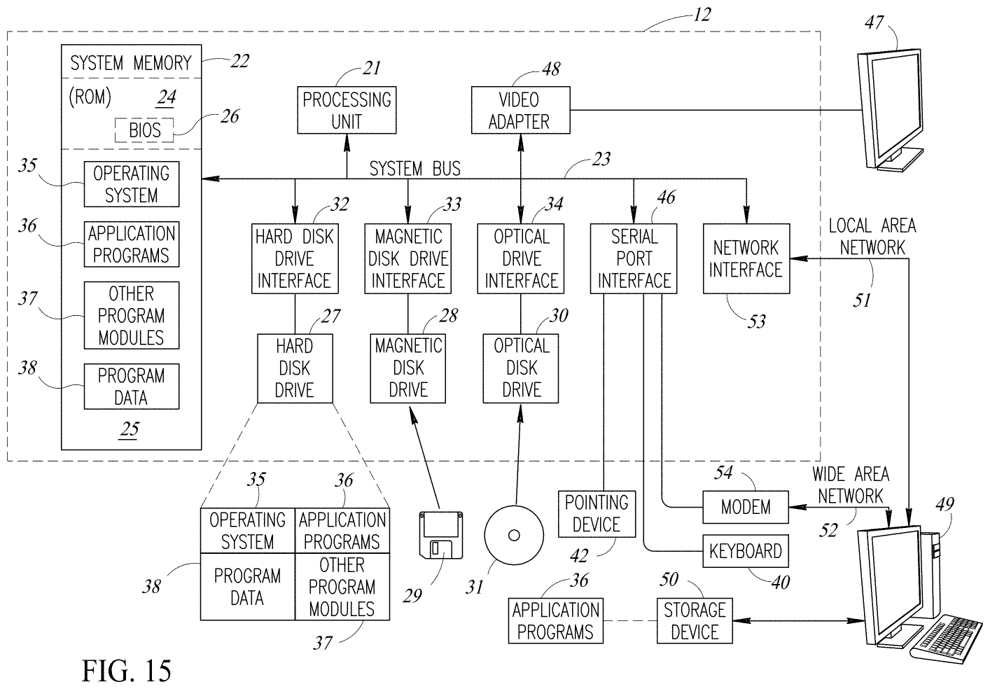

FIG. 15 is a diagram of hardware and an operating environment in conjunction with which implementations of the one or more computing devices of the system 100 may be practiced. The description of FIG. 15 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 15 includes a general-purpose computing device in the form of the computing device 12. Each of the computer system(s) 150 of FIG. 1 may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 15 include a local-area network (LAN) 51 and a wide-area network (WAN) 52. Such networking environments are commonplace in offices, enterprise-wide computer networks, intranets and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores the application 152, which includes computer executable instructions that when executed by one or more processors cause the one or more processors to perform the functions and all or portions of one or more of the methods described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A tower assembly for use with an overhead conveyor, the tower assembly comprising:
a tower frame having a top portion opposite a bottom portion;
a face plate configured to be removably attached to the tower frame, the face plate being configured to support at least one plant as the at least one plant grows when the face plate is attached to the tower frame; and
a connector attached to the top portion of the tower frame, the connector being configured to be removably attached to the overhead conveyor.

2. The tower assembly of claim 1, wherein the tower frame comprises first and second channels that are spaced apart from and aligned with one another,
the face plate comprises a first edge portion opposite a second edge portion, and
the face plate is removably attached to the tower frame by sliding the first and second edge portions into the first and second channels.

3. The tower assembly of claim 2, wherein the tower frame comprises a through-hole in communication with the first channel, and the tower assembly further comprises:
a pin received inside the through-hole and extending into the first channel, the pin preventing the face plate from sliding downwardly with respect to the tower frame.

4. The tower assembly of claim 2, wherein the face plate is a first face plate, the at least one plant is at least one first plant, the tower frame comprises a front side opposite a back side, the front side comprises the first and second channels, the back side comprises third and fourth channels that are spaced apart from and aligned with one another, and the tower assembly further comprises:
a second face plate comprising a third edge portion opposite a fourth edge portion, the second face plate being removably attachable to the tower frame by sliding the third and fourth edge portions into the third and fourth channels, respectively, the second face plate being configured to support at least one second plant as the at least one second plant grows when the second face plate is attached to the tower frame.

5. The tower assembly of claim 4 for use with a watering system, wherein a first pathway is defined between the tower frame and the first face plate, a second pathway is defined between the tower frame and the second face plate, and the tower assembly further comprises:
a first irrigation funnel positioned near the top portion of the tower frame and configured to receive a first portion of water and nutrients from the watering system when the connector is attached to the overhead conveyor, the first irrigation funnel being configured to channel the first portion of water and nutrients to the first pathway, the first portion of water and nutrients flowing down the first pathway to the at least one first plant; and
a second irrigation funnel positioned near the top portion of the tower frame and configured to receive a second portion of water and nutrients from the watering system when the connector is attached to the overhead conveyor, the second irrigation funnel being configured to channel the second portion of water and nutrients to the second pathway, the second portion of water and nutrients flowing down the second pathway to the at least one second plant.

6. The tower assembly of claim 5, wherein the first and second irrigation funnels are attached to the connector, and
the first and second irrigation funnels are positioned above the top portion of the tower frame.

7. The tower assembly of claim 1, wherein the face plate comprises a plurality of baskets, and
the at least one plant comprise a different plant planted in each of the plurality of baskets.

8. The tower assembly of claim 7, wherein the plurality of baskets are arranged in a linear pattern that extends along the face plate.

9. The tower assembly of claim 1 for use with the overhead conveyor comprising a plurality of load bars each moved along the overhead conveyor by at least one movable trolley, each of the plurality of load bars comprising a seat, wherein the connector is a hook configured to be positioned in the seat of a selected one of the plurality of load bars and to hang the tower frame from the selected load bar.

10. The tower assembly of claim 1 for use with the overhead conveyor comprising a plurality of load bars each moved along the overhead conveyor by at least one movable trolley, each of the plurality of load bars comprising parallel first and second rails, a first seat being formed in the first rail, a second seat being formed in the second rail, the first seat being aligned with the second seat, wherein the connector is a hook comprising a downwardly extending projection configured to be positioned between the first and second rails of a selected one of the plurality of load bars when the hook is positioned in the first and second seats of the selected load bar and the tower frame is hanging from the selected load bar.

11. The tower assembly of claim 1 for use with a watering system, the tower assembly further comprising:
an irrigation funnel positioned near the top portion of the tower frame and configured to receive a portion of water and nutrients from the watering system when the connector is attached to the overhead conveyor, the irrigation funnel being configured to channel the portion of water and nutrients to the at least one plant.

12. A hydroponic vertical farm system comprising:
an overhead conveyor comprising a plurality of movable trolley assemblies;
a plurality of vertical grow tower assemblies each comprising a connector, at least one irrigation funnel, a tower frame, a front face plate, and a back face plate, the connector being configured to removably connect the tower frame to a selected one of the plurality of movable trolley assemblies, the front and back face plates being removably attachable to the tower frame, the front and back face plates each being configured to support plants when the front and back face plates are attached to the tower frame and the tower frame is connected to the selected movable trolley assembly;
a lighting system configured to deliver light to the plants supported by the front and back face plates of each of the plurality of vertical grow tower assemblies; and
a watering system configured to deliver water and nutrients to the at least one irrigation funnel of each of the plurality of vertical grow tower assemblies, the irrigation funnel of each of the plurality of vertical grow tower assemblies being configured to receive a portion of the water and nutrients delivered by the watering system and to conduct the portion of the water and nutrients to the plants supported by the front and back face plates of the vertical grow tower assembly.

13. The hydroponic vertical farm system of claim 12, further comprising:
a robot configured to connect the connector of each of the plurality of vertical grow tower assemblies to one of the plurality of movable trolley assemblies and to disconnect the connector of each of the plurality of vertical grow tower assemblies from the plurality of movable trolley assemblies.

14. The hydroponic vertical farm system of claim 13, wherein the overhead conveyor has first and second regions,
the robot is positioned to connect and disconnect the plurality of vertical grow tower assemblies with the plurality of movable trolley assemblies in the first region, and
the plurality of vertical grow tower assemblies are positioned in the second region to allow the plants to grow.

15. The hydroponic vertical farm system of claim 12, further comprising:
at least one computing system configured to control the overhead conveyor.

16. The hydroponic vertical farm system of claim 15, wherein the at least one computing system is configured to control the watering system.

17. The hydroponic vertical farm system of claim 15, wherein the at least one computing system is configured to control the lighting system.

18. The hydroponic vertical farm system of claim 12, wherein for each of the plurality of vertical grow tower assemblies:
a first pathway is defined between the tower frame and the front face plate;
a second pathway is defined between the tower frame and the back face plate; and
the at least one irrigation funnel comprises front and back irrigation funnels positioned near a top portion of the tower frame, the front irrigation funnel being configured to receive a first portion of water and nutrients from the watering system and to channel the first portion of water and nutrients to the first pathway, the first portion of water and nutrients flowing down the first pathway to the plants supported by the front face plate, the back irrigation funnel being configured to receive a second portion of water and nutrients from the watering system and to channel the second portion of water and nutrients to the second pathway, the second portion of water and nutrients flowing down the second pathway to the plants supported by the back face plate.

19. The hydroponic vertical farm system of claim 18, wherein for each of the plurality of vertical grow tower assemblies:
the front and back irrigation funnels are attached to the connector, and
the front and back irrigation funnels are positioned above the top portion of the tower frame.

20. The hydroponic vertical farm system of claim 12, wherein the front face plate comprises a plurality of front baskets,
the plants supported by the front face plate are planted in the plurality of front baskets,
the back face plate comprises a plurality of back baskets, and
the plants supported by the back face plate are planted in the plurality of back baskets.

21. The hydroponic vertical farm system of claim 20, wherein the plurality of front baskets are arranged in a linear pattern that extends vertically along the front face plate, and
the plurality of back baskets are arranged in a linear pattern that extends vertically along the back face plate.
